(19) United States
(12) Patent Application Publication
(10) Pub. No.: US 2025/0367069 A1
(43) Pub. Date: Dec. 4, 2025

(54) METHOD FOR REDUCING PAIN AND RESTORING TISSUE FUNCTION USING VIBRATIONAL STIMULI OF DIFFERENT FREQUENCIES

(71) Applicant: Amy Baxter, Atlanta, GA (US)

(72) Inventor: Amy Baxter, Atlanta, GA (US)

(21) Appl. No.: 18/680,972

(22) Filed: May 31, 2024

(51) Int. Cl. A61H 23/02

(52) U.S. Cl. CPC A61H 23/0254; A61H 2201/0221; A61H 2201/5007; A61H 2201/5035

(57) ABSTRACT

A method and apparatus for reducing pain by simultaneously applying vibrational pressure waves at multiple frequencies such that constructive interference of the compression waves occur within an area to be treated. Embodiments of the present invention can include multiple vibrational motors, each of which can be coupled to a single vibration plate and/or some or all of which can be coupled to separate vibration plates. A controller preferably simultaneously controls all or a subset of all of the motors. The apparatus preferably includes a patient attachment device which enables one or more vibration plates to be coupled directly to an area to be treated on the patient without the need of the patient or a care provider to physically hold the vibration plate against the patient. Optionally, the frequency of the vibrational motors can be modulated during treatment.

### STATEMENT REGARDING FEDERALLY SPONSORED RESEARCH OR DEVELOPMENT

This invention was made with government support under Award No. 3R44DA049631-03S1, awarded by the National Institutes of Health. The government has certain rights in the invention.

### CROSS-REFERENCE TO RELATED APPLICATIONS

Not Applicable.

### BACKGROUND OF THE INVENTION

Embodiments of the present invention relate to the reduction of pain transmission and pain reduction as a consequence of restoration of function using vibrational stimuli applied to a patient simultaneously at two or more frequencies simultaneously. More particularly, embodiments of the present invention relate to a method and apparatus for simultaneously applying at least two different frequencies of vibrational energy, with or without additional synergistic thermal and/or pressure enhancements to a patient's back or abdomen to promote pain management.

Low back pain (“LBP”) is the greatest chronic pain and disability burden worldwide. impacts women's ability to work, care for children, and engage in healthy activity in and out of the home throughout the lifespan. Incidence is forty-eight percent (48%) during pregnancy, and prevalence averages sixty percent (60%) after menopause-twice that of men. Chronic LBP (“CLBP”) after injury causes healthcare inequity, and is the most likely pain condition to lead to opioid dependence. Treating acute low back pain (“ALBP”) can prevent CLBP, but most people wait years for treatment. Treatments that improve muscle health and prevent CLBP, like yoga, thermal therapies, exercise, stretching, acupuncture, massage, and good nutrition, are time-consuming, unreimbursed, and financially out of reach for most. The problem of LBP needs a sensible drug-free solution.

Pain is the body's language of physical safety. Unpleasant nerve signals from the body are amplified by inflammation, then modified by movement-nerve messaging in the spinal cord. The modulated message reaches the brain and is addressed and perceived in the context of past experiences, including risk, meaning, and the potential for control over the pain. Free nerve endings on myelinated a-delta fibers cluster in Schwann cells, leading to pain with movement when the endings are irritated or damaged.

Yearly, $200 Billion is spent on LBP in the US. Both ALBP and CLBP are addressed with opioids, bracing, injections of steroids and oral anti-inflammation drugs. CLBP surgeries deaden irritated nerves, cement spinal vertebrae, or implant electrical stimulation to try to stop pain transmission. Immobilization, whether from bracing or spasm, initiates fatty changes in the muscles within a week, causing more pain. Epidural steroids have a thirty percent (30%) failure rate after two weeks and limited use before causing bone damage. While surgeries solve about ten percent (10%) of causes, ninety percent (90%) of people aren't good surgical candidates. Spine bone surgery still fails in forty percent (40%) of cases, and often leads to post-op complications or opioid dependence. Spinal cord electrical stimulation has failed to perform better than sham surgery or standard care. A new therapy, implanted electrical stimulation of the multifidus muscle stabilizing the spine, has had excellent five-year results improving muscle quality and reducing pain, but is costly and invasive. Current practice fails by trying to block transmission of pain without understanding and addressing the causes.

In the 1950s vibration was hypothesized to “shut the gate” on fast pain. In the early 1990s the motion-sensing nerves' neurotransmitters responsible were identified. “Neuromodulation”, or blocking pain nerve transmission, gives short term relief until the neurotransmitters have to be re-stocked. With her first NIH grant, the inventor created a 200 hertz (“Hz”) vibration device that reduced needle pain by eighty percent (80%). What's new is that now over 100 studies show clinical efficacy with this one-motor device, key for supporting empowerment and trust when the device is first put on. Neuromodulation is part of a solution, but not a treatment. Multiple other mechanisms by which vibration reduces pain have been identified.

LBP is ongoing, not short term, but other frequencies of vibration may be acting on muscles. Studies in the early 1980s found 100 Hz applied in a vibrating back plate was superior to electrical stimulation, with time-dependent sustained relief. A promising stealth target found in the last decade is the muscles that stabilize the spinal cord: multifidus and erector spinae. After injury or changes from aging or bad posture, overuse causes their metabolic requirements to outgrow the blood supply, leading to lactic acid pain. Fatty infiltration of an immobilized muscle will further reduce blood flow, and cause pain from degradation of the muscle. The back muscles shrink, and the fascia covering (with 10× more pain reported than from muscle or skin) gets stuck. Loose pain nerve endings, recently described to be anchored in Schwann cell hubs, may be located in the fascial layer, which is surrounded by a substance that is solid until moved or vibrated or warmed. Decreased fascial movement and muscle shear has been observed in the lumbar muscles of people with CLBP, compared to smooth movement in people without low back pain.

It has been found that a vibrational stimulus at a frequency of 200 Hz alone reduced spine pain 2.8 times better than electrical stimulus. In a feasibility trial designed with the Food and Drug Administration (“FDA”), 20 minutes of the multimodal plate with either hot or cold decreased acute and chronic low back pain (“CLBP”) by fifty-seven (57%), lasting 4.5 hours, with better results in women.

Pain perception is contextual. Doctors have a monocular, hierarchical view of solutions, perhaps arising from one-right-answer entry exams. Solving the biggest cause of chronic pain and opioid use in women first, and with a home-use multimodal solution with the potential for precise personalization, will legitimize losing the one-answer fits all model of medicine. In addition, providing a patient with the ability to address his or her pain enables the patient to feel empowered in their management of pain.

Chronic low back pain is a pervasive scourge on people and healthcare systems which has only been effectively addressed for a small percentage of people through invasive medical procedures or through prolonged-use drugs—many of which are habit-forming and lead to numerous addictions. There is thus a present need for a method and apparatus to reduce pain associated with CLBP and which is not invasive and which does not create dangerous drug dependencies.

### BRIEF SUMMARY OF EMBODIMENTS OF THE PRESENT INVENTION

Embodiments of the present invention relate to a method for providing treatment including attaching a vibration plate to a patient, activating a first vibration motor that is rigidly attached to the vibration plate such that the first vibration motor emits or otherwise imparts at least a first vibration frequency, activating a second vibration motor that is rigidly attached to the vibration plate such that the second vibration motor emits or otherwise imparts at least a second frequency, creating a harmonic combination of the first frequency and the second frequency within the rigidly attached vibration plate and transferring the thusly-created harmonic combination into tissue of the patient, and thermally heating or cooling the vibration plate with a heating and/or cooling source while the first and second vibration motors are activated. The method can also include activating a third vibration motor, rigidly attached to the vibration plate to emit or otherwise impart at least a third vibration frequency.

In one embodiment, the method can include modulating at least one of the first vibration motor and/or the second vibration motor such that the vibration frequency emitted or otherwise imparted thereby is caused to modulate. The method can further include modulating the first vibration motor and the second vibration motor such that a vibration frequency created by the first motor and a vibration frequency created by the second motor is caused to modulate. Optionally, a modulation pattern of the first motor can be different from a modulation pattern of the second motor. The treatment can include providing pain relief and/or restoration of tissue function. The method can also include activating a third vibration motor rigidly attached to the vibration plate. Thermally heating or cooling the vibration plate with a heating and/or cooling source can include heating the vibration plate with an electric heater, with an electric cooler, and/or with an externally heated or cooled thermal pack.

In one embodiment, the method can also include providing a plurality of pre-programmed, user selectable vibration settings and/or allowing a user to manipulate an intensity level of at least one of the first or the second vibration motors. The method can also include shaping the vibration plate to at least substantially conform to at least a portion lower back of a person.

Embodiments of the present invention also relate to a method for improving the ability of fascia to move with respect to a muscle, the method including attaching a multi-frequency vibration apparatus to the patient such that a vibration plate thereof is disposed on an exterior of the patient nearest the fascia, activating a plurality of motors at frequencies that cause a harmonic combination to be formed in the vibration plate. The method can also include modulating a frequency of at least one of the plurality of motors and/or modulating a frequency of the first motor and a frequency of the second motor. The method can also include applying heat to the vibration plate and/or removing heat from the vibration plate to provide a cooling effect to the patient. Optionally, attaching a multi-frequency vibration apparatus to the patient can include attaching the multi-frequency vibration apparatus against a lower back of the patient.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a drawing which illustrates of a perspective view of a multi-frequency delivery device according to an embodiment of the present invention;

FIG. 2A is a drawing which illustrates an exploded view of various parts and components that can be used to provide a multi-frequency delivery device;

FIG. 2B is a drawing which illustrates an exploded view of an embodiment of the present invention with the controller components and the patient attachment device removed to clearly illustrate a configuration of the motors with respect to the vibration plate;

FIG. 2C is a drawing which illustrates an perspective view of the components of FIG. 2B but in an assembled configuration;

FIG. 2D is a drawing which illustrates a cross section view of a massage assembly with a patient attachment device to illustrate the relative positioning of the various components with respect to the vibration plate;

FIG. 3 is a drawing which illustrates a rear perspective view of a multi-frequency delivery device according to an embodiment of the present invention;

FIG. 4A is a drawing which illustrates a front view of a plurality of vibration motors connected to a wiring harness, according to an embodiment of the present invention;

FIG. 4B is a drawing which illustrates a top view of a plurality of vibration motors coupled to a conductor bundle;

FIGS. 5A, 5B, and 5C are drawings which respectively illustrate a top view (5A), a front view (5B), and a front perspective view of a rear vibration motor bracket according to an embodiment of the present invention;

FIGS. 5D, and 5E are drawings which respectively illustrate a top perspective view (5D) and a right side view (5E) of a rear vibration motors bracket according to an embodiment of the present invention;

FIG. 6 is a drawing which illustrates a perspective front view of a motor gasket according to an embodiment of the present invention;

FIGS. 7A and 7B are drawings which respectively illustrate a front perspective view (7A) and a rear view (7B) of a front of a controller housing according to an embodiment of the present invention;

FIG. 8 is a drawing which illustrates a left end view of the controller housing according to an embodiment of the present invention;

FIGS. 9A and 9B are drawings which respectively illustrate a front view (9A) and a rear view (9B) of a multi-frequency delivery device disposed on a user;

FIG. 10 is a drawing which illustrates a direct connection from a rotating counterweight to a vibration plate according to an embodiment of the present invention;

FIG. 11 is a drawing which illustrates a linear drive actuator that can be used as a vibration motor according to an embodiment of the present invention;

FIG. 12 is a drawing which illustrates a front perspective view of a multi-frequency delivery device having a plurality of vibration plates according to an embodiment of the present invention;

FIG. 13A is a drawing which illustrates a top view of a multi-frequency delivery device having a single vibration assembly creating localized enhanced vibrational areas at various distances from the vibration plate;

FIG. 13B is a drawing which illustrates a top view of a multi-frequency delivery device having a plurality of vibration assemblies creating localized enhanced vibrational areas at various distances from the vibration plates of the vibration assemblies;

FIG. 14 is a drawing which illustrates a single vibration plate having a curved shape, with a pair of vibration motors attached thereto;

FIG. 15 is a drawing which illustrates a vibration assembly having coupled via a wired connection to a stand-alone controller;

FIG. 16 is a drawing which illustrates a multi-frequency delivery device having a plurality of biofeedback devices coupled thereto;

FIG. 17A is a drawing which illustrates a vibration plate having an opening formed therein to surround a wound and promote wound healing;

FIG. 17B is a drawing which illustrates a plurality of vibration plates disposed such that they at least partially encircle a wound;

FIG. 18 is a drawing which illustrates a plurality of vibration assemblies coupled to a single controller and positioned on opposing sides of an area where treatment is desired; and

FIGS. 19A, 19B, 19C, and 19D are drawings which illustrate harmonic interactions of vibration frequencies applied to a vibration plate.

### DETAILED DESCRIPTION OF THE INVENTION

Referring now to the drawings, vibration delivery device 10 preferably includes patient attachment device 12, which can include for example, a belt or other wearable device that holds vibration assembly 14 against an area on the patient where vibrational energy is desired.

Delivery device 10 is preferably controlled by a user or a care provider by manipulating one or more of inputs of controller 16. Buckle 18 is preferably used to secure attachment device 12 optionally however depending upon the configuration of attachment device 12, buckle 18 need not be provided or can comprise any other material or apparatus to attach and/or adjust delivery device 12 including for example hook and loop tape. For example, attachment device 12 can comprise an article of clothing (for example a compression garment) or other device which need not require a buckle, or could have additional elastic materials capable of pulling the device in more tightly or angling the device to optimize or otherwise improve or enhance contact with an area of pain.

Vibration plate 20 can optionally include openings 21 into which one or more nubs 22, which can form protrusions on vibration plate 20, can be inserted to provide more focused transmission of vibrational energy to an area of the patient. Although nubs 22 are preferably formed from a rigid material, which can include for example a metal and/or plastic material, nubs 22 can optionally be formed from a resilient material, which can include for example a rubber or other elastomeric material. In one embodiment, nubs 22 can be formed from a combination of different materials. Openings 21 and thus nubs 22 can be arranged to provide direct stimulus to or otherwise concentrate therapeutic effect to any desired location, including for example, myofascial trigger points and/or acupressure points, which provide significantly better therapeutic effect than physical therapy alone.

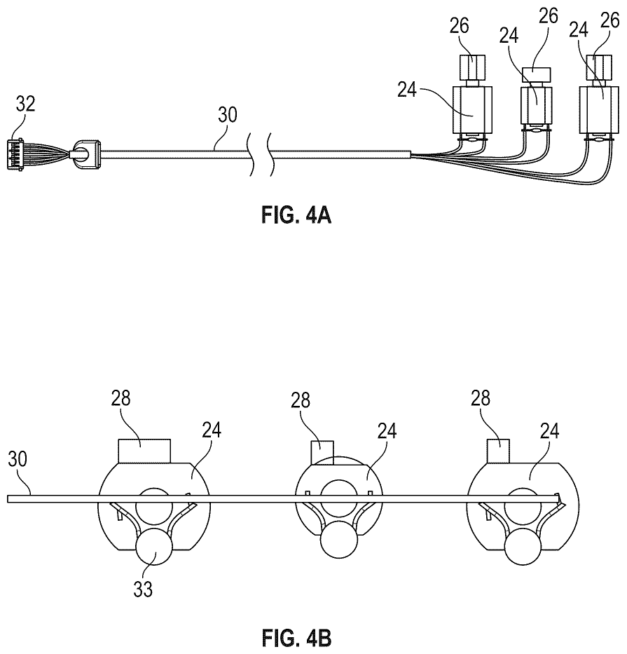

A plurality of vibration motors 24 are coupled to motor power cable 30 which preferably connects to controller 16 via connector 32. One or more sensors 28 can optionally be provided on delivery device 10. As illustrated in FIG. 4B one or more of vibration motors 24 can optionally include sensor 28 coupled thereto. In one embodiment, sensor 28 can comprise an accelerometer or other sensor capable of detecting a speed of the motor or frequency of the vibrations produced thereby. Delivery device 10 can thus be configured to sense when a motor's vibrational balance is compromised or otherwise not as desired and can thus adjust the speed of the motor or shut it off. The accelerometers can also provide feedback about movement of the patient and/or about the vibrational speed of each of the motors.

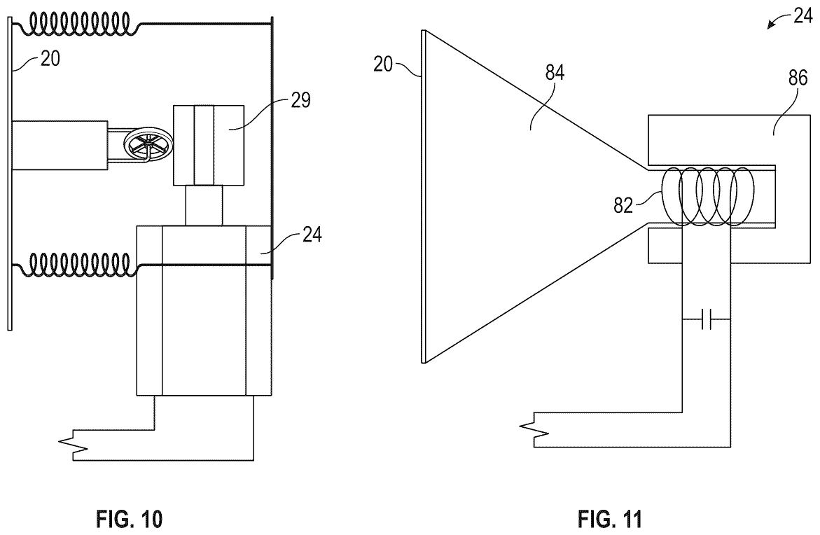

Although the various figures that illustrate the vibration motors show three motors being used in one embodiment, two or more motors can optionally be provided. The term “motors” as used throughout this application is not intended to be limited to rotational motors but can include linear actuators or any other apparatus or device that can provide a vibrating effect or force. For example, see FIGS. 10 and 11. FIG. 10 illustrates a directly coupled rotational vibration motor while FIG. 11 illustrates an example wherein vibration motor 24 is a linear actuating motor, wherein coil 82 disposed within permanent magnet 86, which coil can be coupled to translating member 84 which can be coupled to vibration plate 20. Although FIGS. 10 and 11 illustrate a single vibration motor 24 coupled to vibration plate 20, it is to be understood that any desired number of vibration motors 24 can optionally be attached to the same vibration plate and the two or more vibration motors 24 coupled to vibration plate 20 can be caused to vibrate at the same frequency or a different frequencies. Vibration Motor 24 is shown with the torque of the eccentric flywheel perpendicular to vibration plate 20, in one embodiment, vibration motors 24 can be mounted in parallel with the plate 20, or may have different orientations to achieve different patterns of force transmission in the plate. Motors 24 are preferably rigidly coupled vibration plate 20 such that energy from the motor is transmitted to plate 20 with little to no loss in energy. By coupling motors 24 directly to one or more vibration plates 20, vibration motors 24 can predictably and repeatably deliver force thereto. This is especially helpful because a plurality of frequencies are preferably being input into a single plate 20 by a plurality of motors 24. Accordingly, the vibrations of one motor are imparted to the one or more other motors. Accordingly, if one or more of the motors is not rigidly coupled to vibration plate 20, the vibrations induced by other motors coupled to plate 20 can result in the non-rigidly coupled motor(s) periodically moving or otherwise being forced away from plate 20, which can result in the motor failing to maintain a consistent connection to the plate and thus resulting irregular or otherwise unpredictable transmission of vibrational energy from the non-rigidly coupled motor. In one embodiment, gasket 35 can be disposed between front motor mount 34 and vibration plate 20 and still be considered a rigid connection.

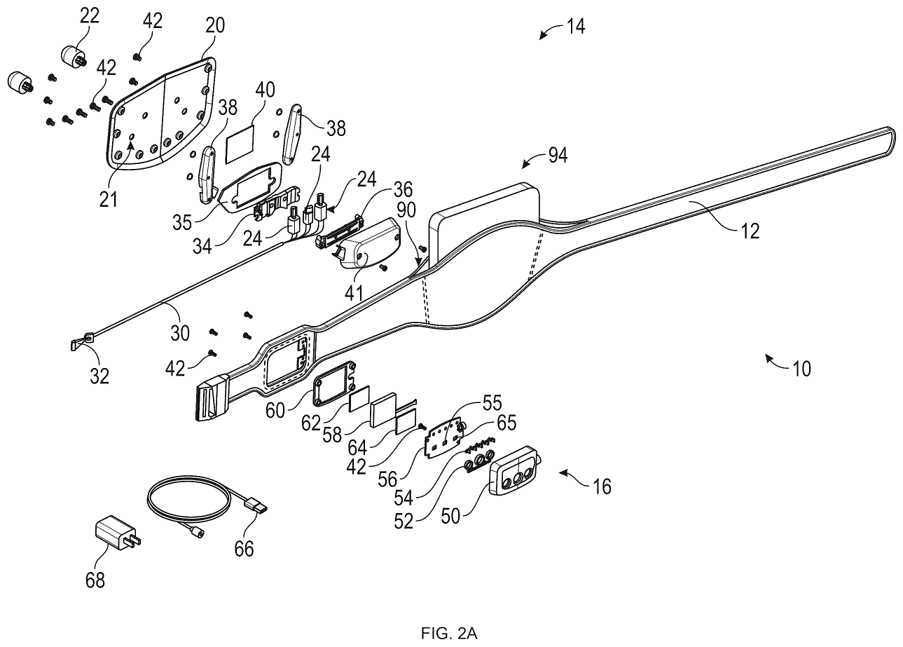

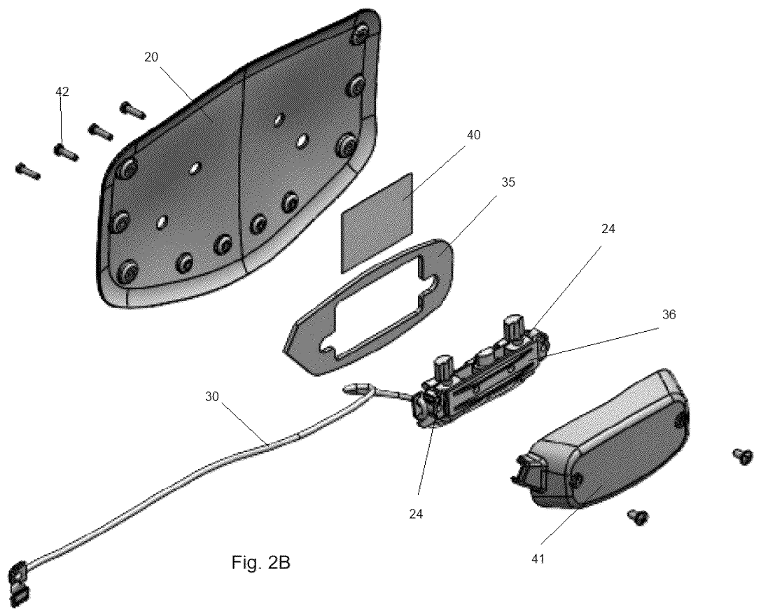

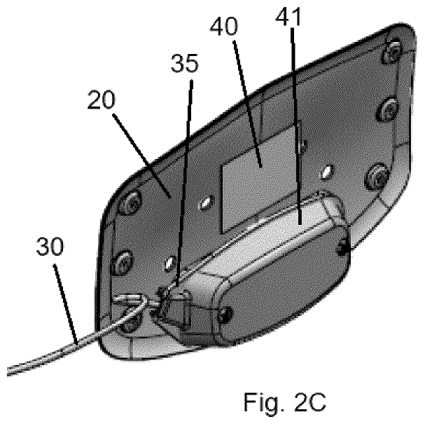

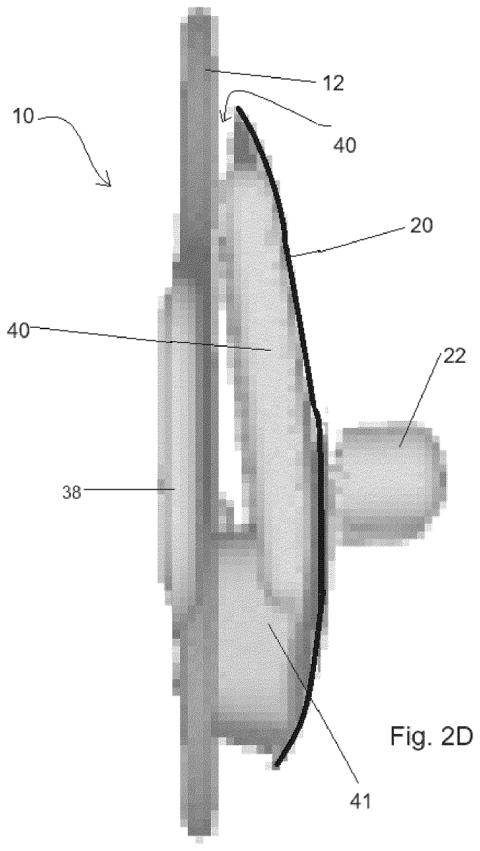

As can best be observed in FIGS. 2B-2D, in one embodiment, motors 24 and associated mounts are preferably coupled directly to a rear surface of vibration plate 20 (with or without intervening portion of gasket 35, via fasteners 42 and are covered by rear covering 41. In one embodiment, rear covering 41 does not extend the entire height of vibration plate 20 and most preferably extends less than half the height of vibration plate 20. In one embodiment, motors 24 are attached to vibration plate in only the lower half of vibration plate 20, thus leaving an upper half of vibration plate open for thermal conductivity to a thermal pack 40 or thermal pad 94.

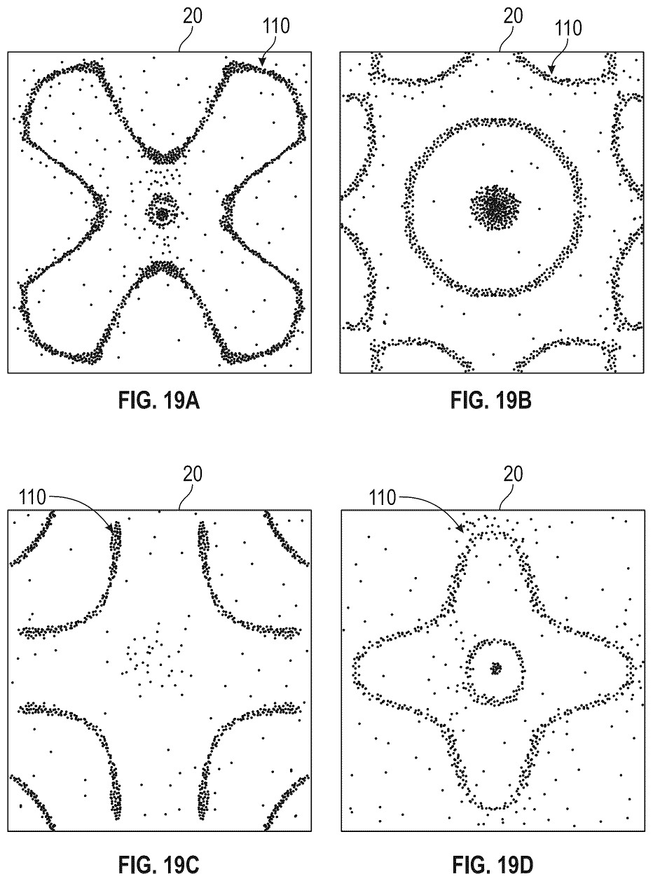

In one embodiment, as best illustrated by the examples of Chladni plate illustrations of FIGS. 19A-19D, by rigidly coupling vibration motors (not shown) to vibration plate 20, harmonic vibrational patterns 110 (also referred to occasionally herein as a “harmonic pattern”) can be created and transmitted to the tissue of the patient. When vibration plate 20 is held against an area of a patient, these harmonic vibrational patterns 110 transmit vibrational energy directly into the tissue of the patient and can create localized enhanced vibrational areas 100 within tissue of the patient, thus providing an enhanced therapeutic effect beyond what that of conventional vibrating devices. In one embodiment, vibration plate 26 is preferably configured to avoid vibrationally-dampening shapes and structures. For example, in one embodiment, plate 26 does not have a rolled or bent lip edge formed thereon, which would tend to dampen vibrations of vibration plate 26.

Rigid vibrating plates—typically of metal, have resonant frequencies and harmonics of the resonate frequency, which can generate different harmonic patterns in response to various frequencies. By changing the shape, thickness and material of the plate, as well as other physical features and structures (for example holes or openings formed therein) the amount of vibration it transmits, and thus the harmonic patterns it is capable of are changed. Changing frequencies applied to the plates also changes the harmonic patterns that are produced. For example, when a frequency that is not a resonant frequency of the plate nor a harmonic thereof is applied to the plate, a harmonic pattern, as referred to herein, is not produced. Vibration plate 20 is preferably formed from a metallic material and is preferably configured to have a resonant and/or harmonic frequency within a range of about 40 Hz to about 300 Hz. Configuring vibration plate 20 to have a resonant or harmonic frequency within this range can include adjusting the choice of material and/or its composition, adjusting the thickness of the material, adjusting the shape of the material—not only the shape when viewed directly from the front, but also when viewed from the side—for example by applying one or more curves or bends to vibration plate 20. Adding, and/or removing openings within vibration plate 20 can also change its resonant and harmonic frequency—this can also include changing the shape of the openings, the location and/or spacing of the openings and the number of such openings. Because frequencies in the range of about 40 Hz to about 300 Hz provide any of various therapeutic effects, in one embodiment, when a targeted treatment has been determined, vibration plate 20 can be shaped and sized to accommodate an area of a human body that is to be treated. In one embodiment, the term “harmonic combination” is intended to mean a combination of vibration frequencies from motors 24 that cause vibration plate 20 to resonate or to otherwise achieve a harmonic frequency thereof. The resonant and/or a harmonic frequency of the thusly-created plate can then be determined—for example, by connecting a piezoelectric or other sensor to the plate, striking the plate to induce a vibration therein, and monitoring the resulting electrical waveform—for example on an oscilloscope, to observe the frequency of the natural resonant frequency of vibration plate 20. Vibration plate 20 can be configured to amplify or otherwise direct a vibration into an area to be treated. For example, plate 20 can be made convex in one or more locations to increase contact force with the use in one or more locations.

When vibration motor 24 is a rotational motor, offset weight 26 can optionally be provided to create the vibrational effect. In one embodiment, each weight 26 of vibration motors 24 can be the same. Alternatively, however, different motors can each have a different amount or position or shape of offset weights applied to them. Optionally, some vibration motors 24 can have matching weights 26 while one or more other motors 24 have one or more different weights 26 applied to them. By changing the mass, position, orientation, shape, or configuration of weights 26 can provide different vibrational forces when connected vibration motor 24 is caused to rotate and these attributes can be selected to treat a different patients (for example old patients vs. children) and/or to treat different anatomical features (for example abdominal or pelvic pain vs. low back or focal muscle pain). In one embodiment, attachment device 12 can comprise one or more straps that are configured to encircle a user's waist or abdomen such that vibration plate 20 is pressed against a user's back and provide harmonic vibrations to the user's back. Optionally, attachment device 12 can press vibration plate 20 against the user's abdomen to provide harmonic vibrations to the user's abdomen.

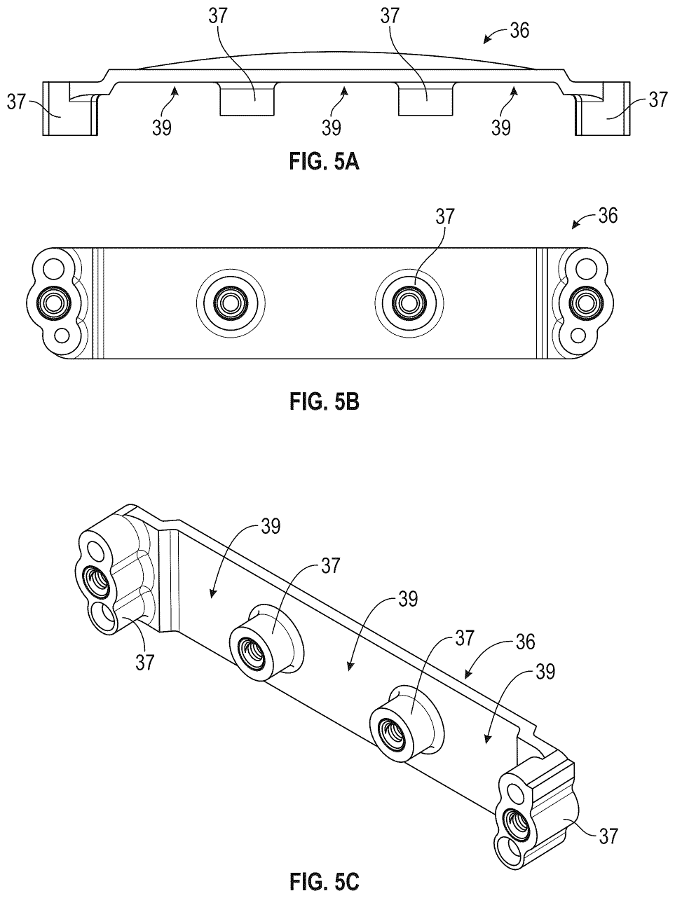

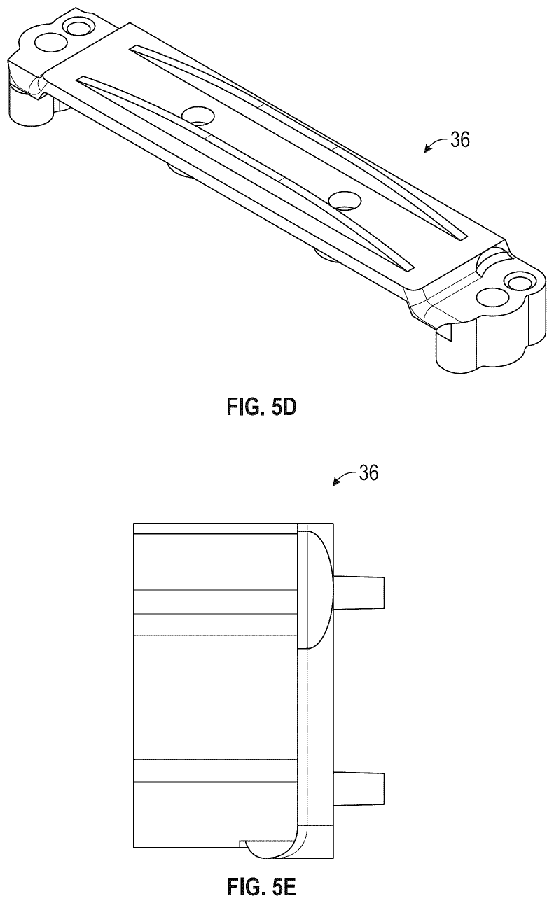

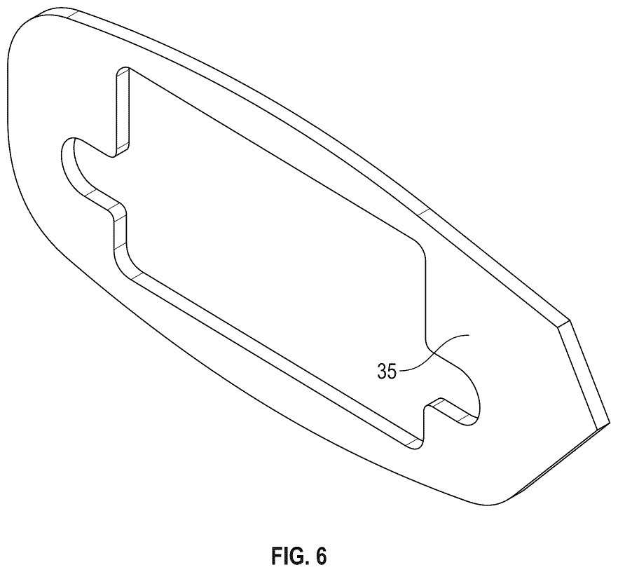

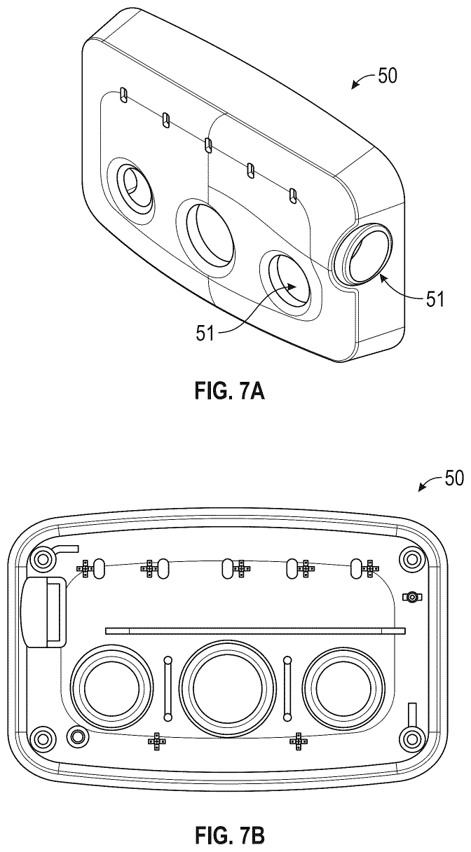

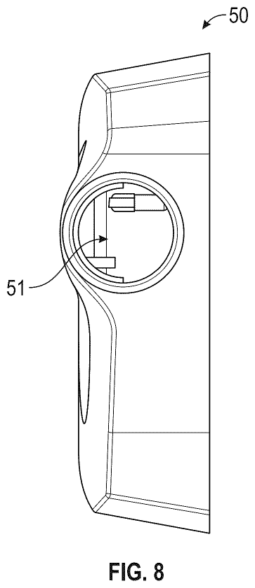

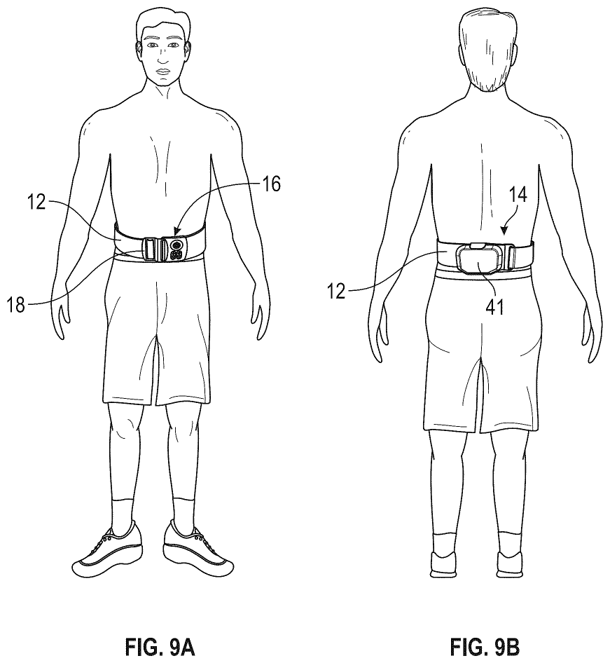

Vibration motors 24 can optionally each have a capacitor 33 to dissipate voltage transients that are created by the switching of the inductive load. Vibration motors 24 are preferably held in between front motor mount 34 and rear motor mount 36. Motor mounts 34 and 36 can be made to accommodate any desirable number of vibration motors 24. For example, as illustrated on FIGS. 5A through 5E, rear motor mount 36 can include a plurality of standoffs 37 that are spaced to create voids 39 to accommodate three motors as illustrated. In this configuration, each of the three motors are held within each of the three voids. Any other motor mount configuration, or plurality of motor mounts, capable of holding one or more motors-such that movement produced thereby or therefrom is translated or otherwise transmitted to vibration plate 20, can also be used and will provide desirable results.

Motor gasket 35, which is most preferably formed form an elastomeric material, can optionally be provided to help create a water-tight seal between around vibration motors 24. Motor gasket 35 can help keep sweat from contacting vibration motors 24—this is particularly helpful when vibration plate 20 is pressed directly against skin of a user. Depending on the shape and configuration of attachment device 12, one or more securing devices 38 can optionally be provided. For example, in one embodiment, if attachment device 12 comprises a belt-like shape, belt cleats can be used as securing devices 38.

In one embodiment, electrically powered thermal pad 40 can optionally be provided. Thermal pad 40 is preferably thermally connected to vibration plate 20. Thermal pad 40 can optionally comprise an electrically heater, electrical cooler (which can include for example a Peltier effect cooler) and/or a combination of one or more heaters and one or more coolers. The vibration produced by a plurality of vibration motors 24 can achieve synergy of tissue and cellular effects by simultaneously providing a predetermined temperature, thus increasing the cellular changes caused by vibration. For example, heat of about 40 degrees centigrade (“C”) to about 45 C and a frequency both independently can be used to liquify hyaluronic acid, allowing for entrapped Schwann cells, which are causing a-delta pain, to be released more effectively than with either modality individually.

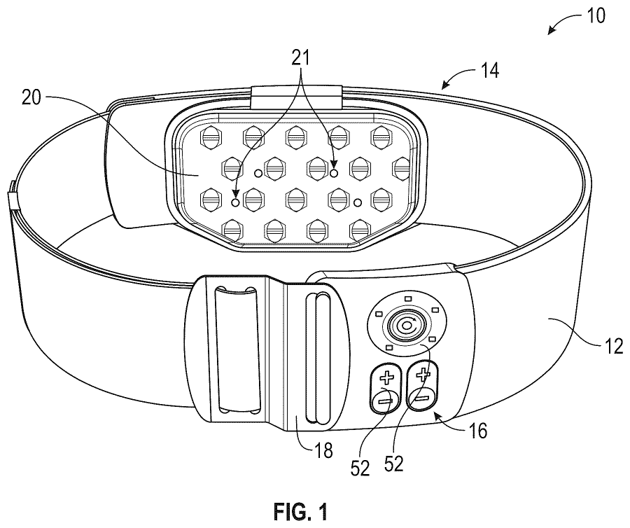

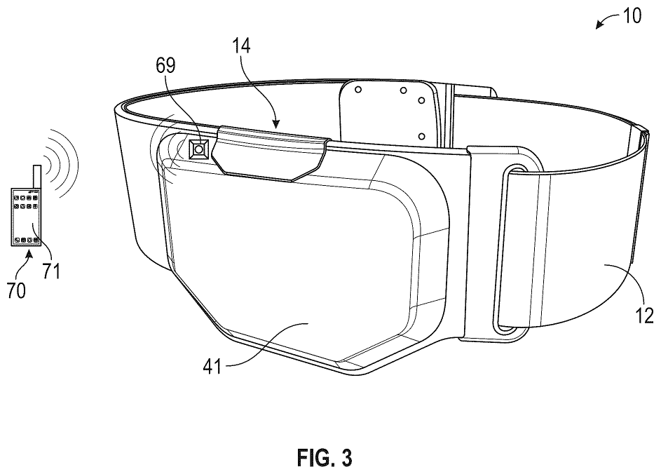

Rear covering 41 is preferably disposed over vibration motors 24. As best illustrated by contrasting the rear view of vibration assembly 14 of delivery device 10 of FIG. 3 with the front view of vibration assembly 14 of FIG. 1, it can be observed that vibration plate 20 is preferably disposed on an inside portion of attachment device 12 while motors that are within rear covering 41 are preferably disposed on a backside of attachment device 12. Of course, desirable results can also be achieved by disposing all of vibration assembly 14 on an inside or an outside of attachment device 12, as long as vibrations are able to be transmitted to the location on the patient where the vibration effects are desired.

As illustrated best in FIG. 2A, a plurality of fasteners 42 are preferably used to secure various parts of delivery device 10 together. For example, in one embodiment, screws or other threaded fasteners are preferably used. Optionally of course, various components of delivery device 10 can be connected together via any other known method apparatus or structure for coupling two or more components together.

Referring now primarily to FIGS. 1 and 2A-2D, controller 16 preferably includes front housing 50 and one or more user input 52. In one embodiment user inputs 52 can include one or more buttons or any other user interface that can enable delivery device 10 to be activated and most preferably to also be manipulated such that different magnitudes of vibration are provided. Haptic shape signaling is preferably used on one or more of user inputs 52. This can include, for example, raised dots applied or formed on various user inputs 52, concave buttons, convex buttons and/or combinations thereof, to facilitate a user in manipulating user inputs 52 by feel. Light emitting diodes 54 or other indicators, which can optionally include a liquid crystal display and/or light pipes coupled to light emitting diodes, can be provided to provide feedback to the user about an on/off state of delivery device 10, other selection options, and/or to provide information about an operating status of delivery device 10. Circuit 56 preferably includes one or more controllers 55, which can optionally include for example a microcontroller and/or a microprocessor.

Power for delivery device 10 preferably comes from battery 58 which can optionally comprise a rechargeable internal battery that is most preferably disposed within a housing of controller 16 but can optionally be disposed anywhere on or in delivery device 10. Battery 58 is most preferably held fast to rear controller housing 60 of controller 16 via adhesive 62, which can optionally comprise a pressure sensitive adhesive. If battery 58 is a rechargeable battery, it can preferably be recharged via connecting cable 66 to other charging device 68.

In one embodiment, sensor 64, which can include a plurality of sensors, and memory 65 (see FIG. 2A) can optionally be provided. Although any desired sensor can be used, in one embodiment, sensor 64 can optionally be an accelerometer, a tilt sensor, and/or an inertial measurement unit. In one embodiment, data from sensor 64 can be used by controller 55 to track use of delivery device 10, a range of motion experienced by the patient, to indicate pain, and/or to detect movement consistent with successful physical therapy. For example, pain can be detected by determining stiffening of the patient, or decreased lateral movement, which are consistent with pain. In response to detecting such pain, vibration motors 24 can be adjusted to reduce the amplitude of the vibrational signal. Memory 65 can optionally be used to record data and/or indications consistent with data from sensor 64 and can optionally be used to store any other information—including for example to log information about the date, time, duration of use, pattern of interactions of the motors, and any other information related to user inputs or manipulations of controller 16.

As best illustrated in FIGS. 2D, pouch 90 can optionally be provided on or in attachment device 12 or otherwise positioned or formed between attachment device 12 and vibration plate 20. A user, or care provider, can then selectively insert thermal pack 94 to provide heating or cooling. In one embodiment, thermal pack 94 can be headed from an outside source, for example a microwave oven or other heat-generating appliance. Optionally, thermal pack 94 can be cooled via an external cooling source, for example a freezer or refrigerator. Optionally, thermal pack 94 can be a self-heating and/or self-cooling pack—for example a chemical heating pack or reusable heating pack, or an instant cooling pack. For externally-heated or cooled thermal packs, after thermal pack 94 has achieved the desired temperature, a user or care provider preferably inserts it into pouch 90 of attachment device 12 and the heat is conducted through vibration plate 20 to and/or from the user. In one embodiment, thermal pack 94 can be formed from a clay material, preferably disposed within a container.

In one embodiment, controller 55 can be configured to cause one or more of vibration motors 24 to follow a preprogrammed sequence of on/off to control a motor and hold at different frequencies with specific cellular functions based on duration and flywheel amplitude. For example, in one embodiment controller 55 can use pulse width modulation to control a voltage applied to one or more vibration motors 24. Optionally, one or more sensors 28 can be used to monitor the speed of vibration motor 24 and/or the frequency of vibration emitted thereby and provide an input to controller 55 to assist in operating vibration motors 24 at predetermined speeds and/or to emit predetermined frequencies. Optionally, controller 55 can use a look-up table to follow predetermined frequencies and/or patterns. In one embodiment, vibration motor 24 can comprise a stepper motor and controller 55 can thus rotate vibration motor 24 at a precise speed without requiring feedback from sensor 28.

Some examples of treatment protocols that can use predetermined frequencies can include fibroblast activity, inhibition of adipogenesis to impact fatty changes in muscles, vasodilation, bone growth, oxytocin release, and/or cellular growth.

Embodiments of the present invention preferably use a plurality of vibration motors 24 to create a plurality of different frequencies of vibration. For example, a first motor can be caused to create a first vibrational frequency while a second motor produces a second vibrational frequency. Optionally more than two frequencies can be provided by more than two vibration motors 24. Optionally, one or more groups of vibration motors 24 can be used to collectively create a single frequency while another motor or group of motors produces a different frequency.

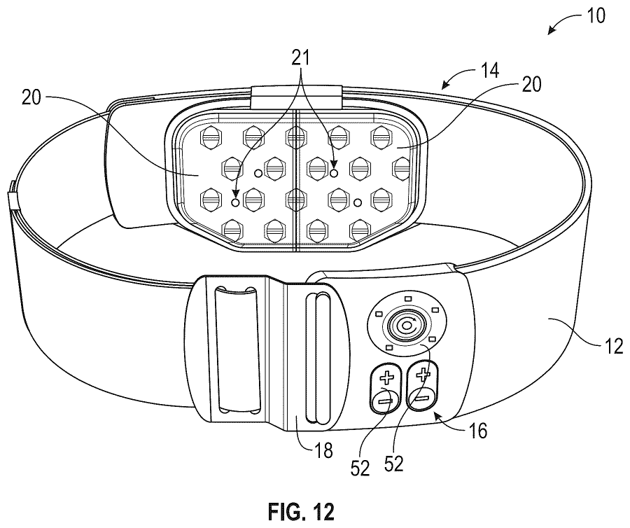

Optionally, the motors creating the two or more frequencies can be disposed within the same vibration assembly 14 and can be coupled to the same vibration plate 20. Optionally, the motors can be disposed within a single vibration assembly 14 but two or more vibration plates can be disposed thereon (see FIG. 12), e.g. for use on either side of an extremity to enhance penetration and strength of the mechanical force administered.

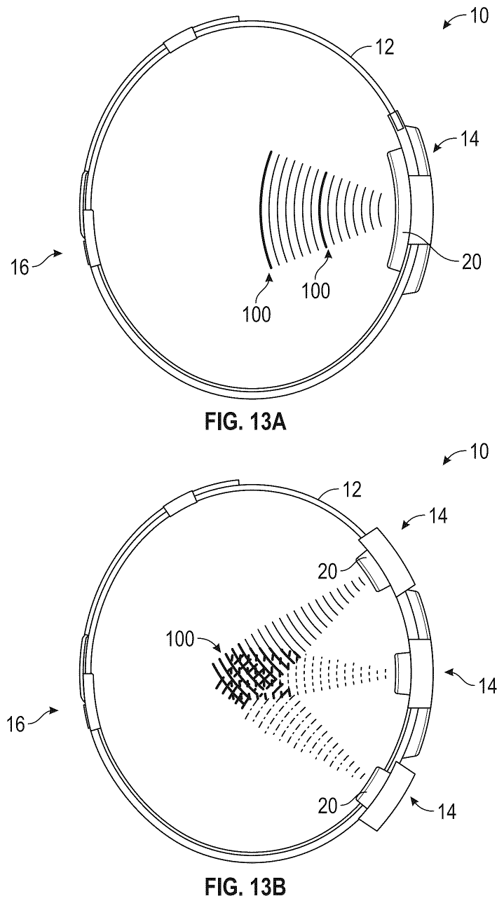

As illustrated in FIG. 13A, in one embodiment, the positioning and speed of vibration motors 24 can be configured such that the compression waves created thereby are caused to constructively interfere with one another to produce localized enhanced vibrational areas 100 at a predetermined depth or range of depths to increase the amplitude of the vibrational signal at that depth or through that range of depths. Optionally, both the first frequency and that second frequency can be held constant to maintain the positioning of the localized enhanced vibrational areas 100 at a consistent location. Optionally, one or both of the frequencies can be changed to cause localized enhanced vibrational areas 100 to sweep through a treatment area or to otherwise set up one or more enhanced vibrational areas 100 that are caused to consecutively and optionally repeatedly step from a first location to one or more other locations. For example, in a stepped configuration, delivery device 10 can create a localized enhanced vibrational area 100 at a depth of 1 inch for 10 seconds, then at a depth of 2.5 inches for 20 seconds and then at a depth of 3.5 inches for 10 seconds before repeating. In a second example, one or more localized enhanced vibrational areas 100 can be caused to form at a depth of 1 inch and then progress to a depth of 4 inches before starting over).

As illustrated in FIG. 13B, in yet a further embodiment, delivery device 10 can comprise two or more vibration assemblies, each of which having one or more vibration plates 20 and each of which can vibrate at one or more frequencies. For example, attachment device 12 can have a plurality of vibration assemblies 14 disposed thereon. In one embodiment, both of the vibration assemblies can be configured to vibrate at the same frequency or at a different frequency. With such a configuration, interference patterns can be used to create one or more localized enhanced vibrational areas 100 where the compression waves from the two vibration assemblies constructively interfere with one another. For embodiments where more than one vibration plate 20 is provided, each of the vibration plates 20 can optionally be controlled separately or together as a group. Separately controlled vibration plates can be particularly useful for stroke rehabilitation or asymmetric strength.

Optionally, instead of adjusting the speed of different vibration motors 24, two or more different motors can instead have different sizes of weight 26, thus producing vibrational harmonics through constructive interference to allow for changed or changing locations of localized enhanced vibrational areas 100.

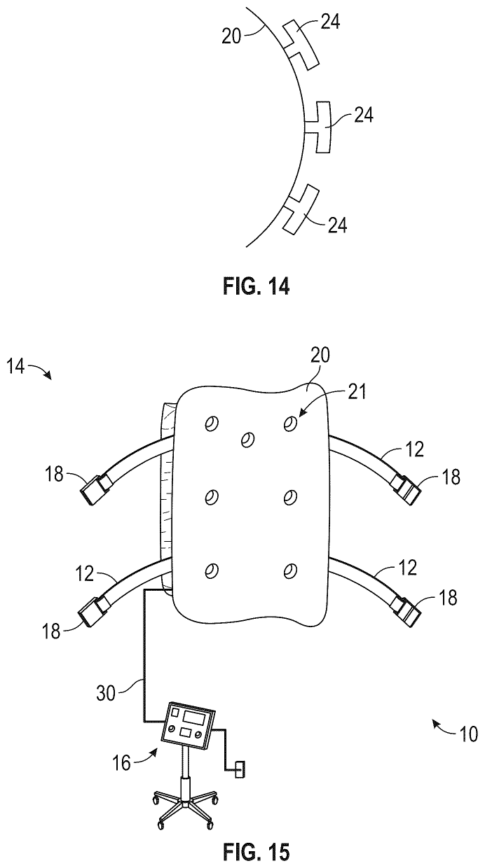

Referring now to FIG. 14, in one embodiment, vibration plate 20 can be formed into any desirable shape with a plurality of vibration motors 24 coupled thereto. For example, to conform to an area the body of a user and/or to concentrate amplitude of vibrations emitted therefrom to a targeted area (for example to concentrate amplitude of vibrations on the piriformis or uterus to reduce spasm and optionally conduct thermal therapy as an adjunct). In one embodiment, vibration plate 20 can be configured to fit the curve of a user's hip—particularly for providing pain relief after hip surgery. In one embodiment, vibration plate 20 can be convex such that a center portion of vibration plate is projected further toward the patient, thus providing a more directed and localized vibrational effect.

As best illustrated in FIG. 3, delivery device 10 can include receiver 69, which can include for example an antenna and controller 16 can include associated circuitry for receiving and interpreting wirelessly transmitted control signals, which can be emitted by remote control 70. Such that a care provider or the patient can control aspects of delivery device 10 remotely—for example from a nursing desk, or controlled from a mobile application or via any other location. In one embodiment, remote control 70 can comprise a computer, smartphone, and/or tablet with application 71. Application 71 need not be actually installed on remote control 70, but can instead function as software as a service through an Internet connection. Application 71 can be configured to allow for minute changes in amplitude of vibrational signals in order to optimize transmission of mechanical energy through biofeedback. Application 71 can also optionally be programmed to keep track of range of motion, a use pattern, physical therapy, and/or to allow users to record or otherwise keep track of his or her diet after an injury, a surgery, or other procedure.

In one embodiment, a removable covering can be disposed over all or a portion of delivery device 10 to enable a single device to be used for sharing between patients and/or to provide infection control. For example, in one embodiment, vibration plate 20 can comprise a lip which enables a removable cover to be placed over it and applied to a first patient and, upon completion of use by the first patient, the cover can be removed and replaced or sterilized before providing delivery device 10 to a second patient. For example, a removable and disposable covering, similar to a shower cap, can be slid or otherwise disposed over vibration plate 20.

Although FIG. 2A illustrates an embodiment wherein delivery device 10 is powered by a battery, in one embodiment, delivery device 10 can be powered directly from an electrical outlet or an external power supply. Likewise, although one embodiment provides controller 16 directly attached or directly attachable to attachment device 12, in one embodiment, controller 16 can be electrically coupled to vibration assembly 14 but not be disposed on attachment device 12. For example, as best illustrated in FIG. 15, delivery device 10 can be coupled via wiring to a separate standalone controller 16 which can be, for example, used in a doctor's office, clinic, or hospital. Optionally, attachment device 12 can comprise a plurality of straps with one or more buckles 18. In this embodiment, controller 16 can optionally comprise battery 58 (not shown) and/or be directly coupled to an electrical outlet with a grounded stationary unit. For embodiments wherein vibration plate 20 is intended to be used from patient to patient, vibration plate 20 is preferably made from a material that is easy to clean and/or is provided with a removable and disposable and/or cleanable covering. Likewise, attachment device 12 is preferably also configured to be easily removed and cleaned or replaced between patient use. For example, if attachment device 12 is one or more straps, they are preferably attachable to vibration plate 20 via a quickly connecting coupler for example via snaps, clips, quick connect buckles, and/or hook and loop tape.

In one embodiment, openings 21 in vibration plate 20 can comprise electrical sockets and nubs 22 can comprise a resistive heating element within them and the portion of nubs that engages into openings 21 can comprise electrical contacts and current can be turned on and/or off and/or otherwise controlled to each of openings 21 via controller 16 such that when nubs having the heating element are disposed within openings 21 and when electrical current is supplied thereto by controller 16, nubs 22 can thus heat to provide heat. Likewise, nubs 22 can have a cooler (for example a Peltier cooler) disposed within them such that when they are inserted into openings 21 and current is supplied thereto, heat will be transferred from an end portion of nubs to vibration plate 20, thus providing a cold sensation. Optionally, some nubs can be provided with insulators or otherwise not electrically coupled such that a provider or user can decide to put any of a heating nub, a cooling nub, or an inert nub into any of openings 21.

In one embodiment, nubs 22 can be formed from a material that retains thermal energy well (for example a ceramic, stone, or metallic material, which can optionally have a void disposed therein and which can thus optionally be filled with material capable of storing thermal energy including for example a clay and/or a gel. In this embodiment, nubs 22 can be removed from vibration plate 20 and can be heated or cooled from an external source (for example a microwave and/or a freezer).

In one embodiment, patient attachment device 12 need not itself directly attach to the patient, but can instead be a structure, apparatus, or device which attaches to something that is attached to a patient. For example, in one embodiment, attachment device 12 can attach at least vibration assembly 14 to a brace or other structure or device which is attached to a patient. Via this connection, vibrational stimulation can be applied to the brace or other device and into the patient, thereby providing mechanical stimulation to a brace to increase healing and decrease pain & fatty changes after surgery or injury. Accordingly, in one embodiment, attachment device 12 can optionally include one or more clips, clamps, side struts or other attachment mechanisms.

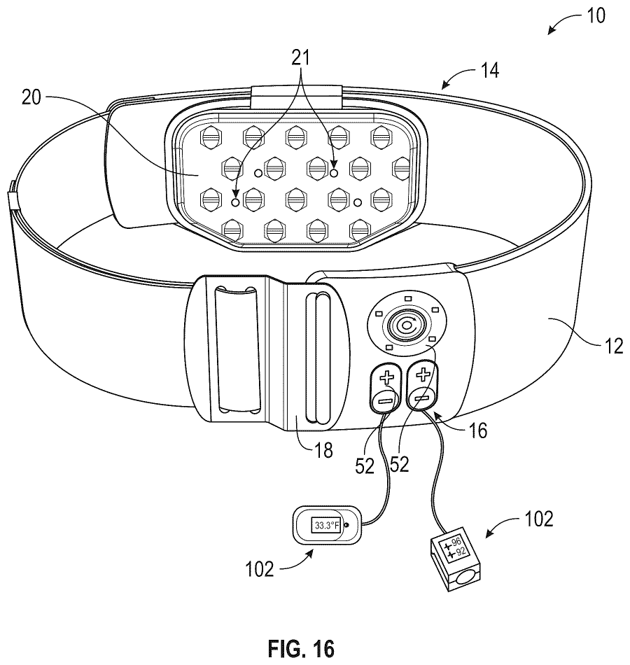

As best illustrated in FIG. 16, one or more biofeedback sensors 102 can be provided and can be positioned to collect information from the patient. Such biofeedback sensors can include one or more: temperature sensors, blood pressure sensors, heart rate sensors, breathing rate sensors, diaphoresis sensors, combinations thereof and the like. In one embodiment, when changes occur, or when predetermined thresholds are reached by one or more biofeedback sensors 102, controller 16 can change aspects of the applied vibrations, including for example, changes in the depth or location of localized enhanced vibrational areas, frequency, amplitude of one or more of the vibrational frequencies, and/or turning on or off one or more of vibration motors 24. Optionally, information obtained from biofeedback sensors 102 can be recorded and stored on memory 65. As one example, biofeedback sensor 102 can be configured and positioned to identify shallow breathing, and upon detection of this, controller 16 can activate one or more vibration motors 24 to retrain the patient during the pain cycles to move and breathe through discomfort through biofeedback.

In one embodiment, controller 55 can include a timer, which can for example be a function of controller 55. Such that one or more of vibration motors 24 can be activated for a predetermined amount of time. In one embodiment, sensor 64 can be an accelerometer, tilt, sensor or other sensor capable of detecting when a patient is or is not moving. In this embodiment, if sensor 64 does not detect patient movement for a predetermined amount of time, delivery device 10 can provide a reminder to the patient to move. For example, in one embodiment, delivery device 10 can emit an audible indication to move or can activate one or more of vibration motors 24 to remind the patient to get up and move about. Optionally, however, if the patient has application 71 installed on his or her smartphone or other device, the delivery device 10 can cause the application to cause the mobile device to emit an audible and/or vibratory alert and/or to issue a visible alert on the display. In addition to issuing this alert for non-movement for a predetermined amount of time, in one embodiment, the alert can be issued if delivery device 10 detects issues with the user's balance from sensor 64 and/or detects that the user is not performing diaphragmatic breathing to a predetermined specification or within a predetermined range.

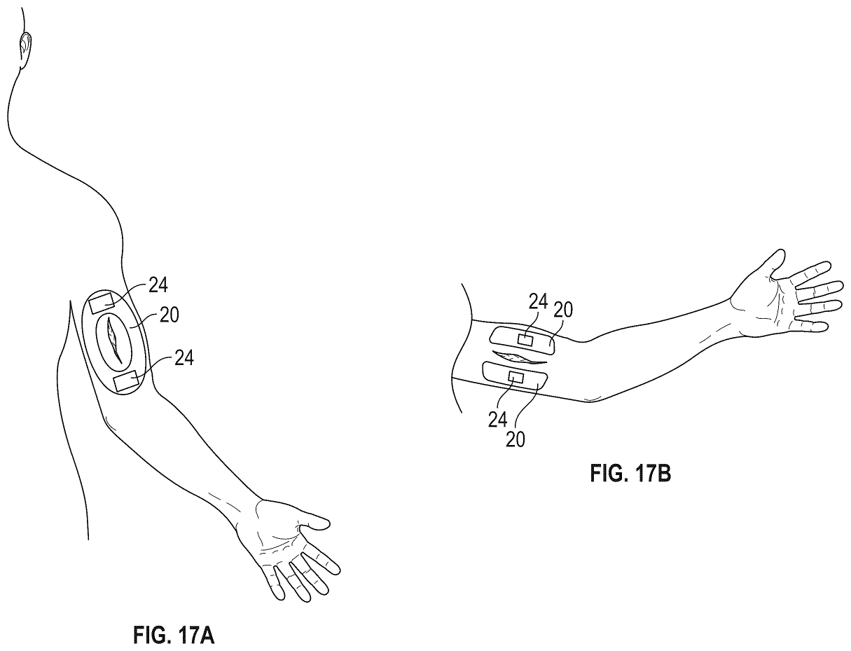

Because one or more frequencies can stimulate cell growth, oxytocin-which increases wound healing, etc., embodiments of the present invention can provide enhanced wound healing by disposing one or more vibration plates 20 proximal to a wound and/or at least partially around the wound. For example, as illustrated in FIG. 17A, vibration plate 20 can have an opening in a center thereof which can be disposed to encircle a wound and thus promote healing. Optionally, one or more vibration plates 20 can be disposed proximate a wound to at least partially encircle the wound (see FIG. 17B). Note that FIGS. 17A and 17B illustrate only a vibration plate and a couple of vibration motors—the remaining portions of delivery device 10 have been removed so that the viewer can illustrate the exemplary placement of the vibration plates proximate the wound. For the configuration of FIG. 17B, each of the two illustrated vibration plates 20 can be coupled to a same controller 16. Any desirable shape and/or profile of vibration plates 20 can be used to provide particularly desirable results for a given anatomical feature and/or location on a body of the user.

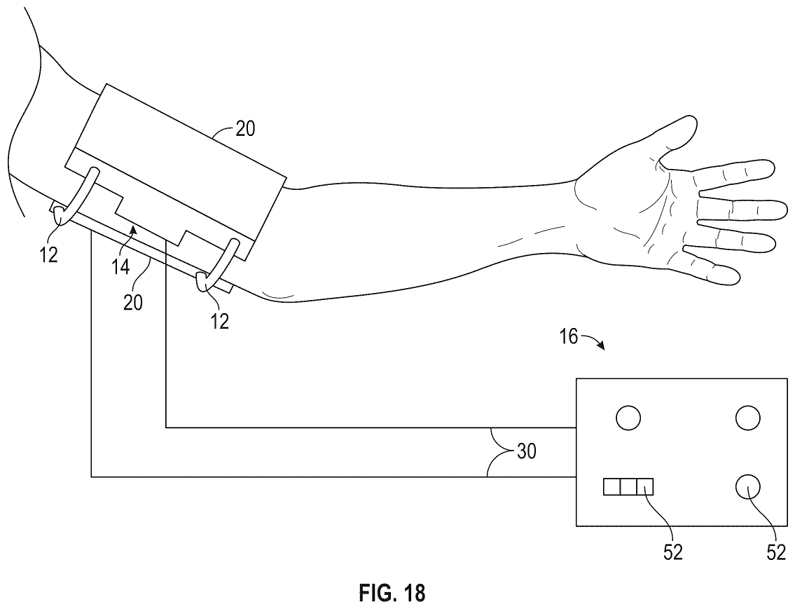

Referring now to FIG. 18, in one embodiment, delivery device 10 can comprise a plurality of vibration plates which can be separated a distance from one another, and which can optionally each have a separate attachment device 12 coupled thereto. In this configuration, although the vibrations of the plurality of vibration plates 20 can be synchronized and/or otherwise simultaneously controlled by a single controller 16, each vibration plate 20 can be attached to a user separately from one another. This configuration enables more customizable treatment options, including the ability to treat an area stereotactically. For example, if a user has an interior shoulder injury, a first of the plurality of vibration plates 20 can be disposed against a posterior of the user's shoulder while a second of the plurality of vibration plates can be disposed against an anterior of the user's shoulder.

Although the foregoing description and some figures illustrate delivery device 10 being used on humans, delivery device 10 can be configured, using the same teachings herein, to provide therapeutic effect to any living animal. In such embodiments, the animal's owner or the care provider can use controller 16 to initiate vibrations or make changes to any of the settings and/or parameters described herein.

In one embodiment, a plurality of vibration motors 24 are provided and controller 55 of delivery device 10 is preferably configured to direct the amount of power being delivered to vibration motors 24 to be ramped, cycled, or otherwise modulated up and down. Optionally, this power modulation can be independent and offset for each motor. For example, if three vibration motors 24 are provided on delivery device 10, in one embodiment, a first motor can cycle from no power, or a predetermined minimum power to a maximum or predetermined maximum power over a predetermined period of time and can then stop, start back at the minimum or can ramp back down to the minimum. Simultaneously, a second motor can do the same modulation technique (or a different modulation technique), but can optionally be out of phase with the modulation cycle of the first vibration motor. Likewise, a third motor can be modulated in the same or a different manner, but is preferably out of phase in its modulation cycle with the first two vibration motors. Optionally, one or more of the motors can be modulated in phase with the modulation cycle of another motor. Optionally, only two vibration motors can be provided. Optionally, more than three vibration motors can be provided.

In one embodiment, controller 55 can be configured to enable any desired amount of power to be delivered to vibration motors 24 within the physical and electrical limitations of motors 24. Optionally, a user can choose to operate any of vibration motors 24 at a desired parameter (for example, the user can have an option of 1 though 10 to adjust the speed and of each vibration motor 24 and/or can choose speed/power ramp rates—this can include the user or provider graphically choosing the speed of each motor and/or the pattern to be followed by each motor (for example on a mobile application that is installed on the user's mobile device). In one embodiment, predetermined settings can be installed on delivery device 10 such that a user can choose from a predetermined list of settings.

While an infinite number of predetermined patterns can optionally be provided, the following is intended to illustrate a few examples of vibrational pattern settings that can be provided-this is of course not an exhaustive list. For example, in one embodiment one or more of the following patterns can be preset for delivery device 10:
1) A first pattern can be a first motor vibrating at a constant 200 Hz while a second motor is inactive.
2) A second pattern can be a second motor vibrating at a constant 100 Hz while the other motors are inactive.
3) A third pattern can be each of three motors modulating up and down from 50 Hz to 100 Hz, wherein the pattern of each motor is offset with respect offset from each of the other motors (i.e. each motor is modulated about a sinewave power curve wherein the sinewave of the first motor has a cycle of one cycle every 15 seconds, the second motor has a sinewave power curve of one cycle every 10 seconds and a third motor has a sinewave power curve of every 5 seconds.
4) A fourth pattern can be ramping up and down of 100 Hz and 200 Hz simultaneously with all motors in sync;
5) A fifth pattern can be ramping up and down of two motors in different patterns;
6) A sixth pattern can be ramping up and down of three motors not in sync and wherein each motor is quickly pulsating on and off during its modulation cycle to achieve a rumble effect;
7) A seventh pattern can be a first motor operating a 50 Hz, a second motor operating at 100 Hz, and a third motor operating at 200 Hz, all constant;
8) An eighth pattern can be cycling through each of the preceding seven patterns on a loop wherein each pattern is operating for 30 seconds before moving to the next pattern;

In one embodiment, each of vibration motors 24 can have an expected range with +/−150 Hz when run continuously. In one embodiment, delivery device 10 can cause:
1) one or more of vibration motors 24 can be operated at a frequency of about 93 Hz to reduce fatty infiltration of an immobilized muscle;
2) one or more of vibration motors 24 can be operated at a frequency of about 60 Hz to reduce inflammation;
3) one or more of vibration motors 24 can be operated at a frequency of about 128 Hz to free fascial Schwann cell hubs, which may be located in the fascial layer, and which is surrounded by hyaluronic acid that is solid until moved or vibrated or warmed to 40 degrees centigrade (thus, in this embodiment, heat is preferably additionally applied to an area to be treated);
4) one or more of vibration motors 24 can be operated at a frequency of between 50 Hz and 150 Hz to provide increased blood flow;
5) one or more of vibration motors 24 can be operated at a frequency of about 50 Hz to about 300 Hz to provide wound healing; and/or
6) one or more of vibration motors 24 can be operated at a frequency of about 75 Hz to about 125 Hz to increase oxytocin.

In one embodiment, delivery device 10 can be configured to transmit vibrational stimulation to decrease fatty changes in injured or braced muscles—for example the multifidus or erector spinae in the lumbar spine, or rotator cuff muscles. The purpose of this is to increase the blood flow and decrease cellular damage and atrophy resulting from fatty changes. Optionally, vibration plate 20 can be shaped to substantially conform to a portion of a user's back to target deeper vibrations and harmonics at certain locations based on etiology of disease (bone, multifidus, erector spinae). Optionally, a combination of frequencies can be emitted by delivery device 10 to increase blood flow and stimulate cellular growth—for example about 90 Hz to increase bone growth and about 150 Hz to increase blood flow to the same area. A combination of frequencies can be emitted by delivery device 10 to activate neuromodulation in the dorsal horn to reduce pain (for example one or more frequencies within a range of about 180 Hz to about 250 Hz), in concert with frequencies to release pain nerves in the fascia and increase muscle anabolism (for example one or more frequencies within a range of about 93 Hz to about 140 Hz). Optionally, external elastic or other securing straps can provide increased pressure of vibration plate 20 against a surface of the user to increase the pressure and compression with increased body habitus.

Delivery device 10 can be used to reduce pelvic pain, including but not limited to menstrual pain, post-operative hysterectomy pain, urinary tract infection pain, and/or chronic bladder pain. Embodiments of the present invention are believed to not only reduce pain transmission short term for visceral or somatic pain. Application of local vibration has been found to prevent and improve single aspects of muscle function with single frequencies. Application of harmonic interactions of mechanical force simultaneously and in sequence repair the support muscles responsible for chronic musculoskeletal pain, and now implicated in lower back pain. Frequencies in the of about 150 Hz are believed to increase blood flow and wound healing. Vibration at about 93 Hz inhibits fatty muscular changes, and may reverse them over time. Vibration at multiple frequencies is believed to increase range of motion through tissue changes when applied for about 30 minutes two to three times daily for 10 days. Varying mechanisms contribute to the changes, including fascial release previously described, decreased Calcitonin gene-related peptide inflammation enhancers in the dorsal nerve roots to the spine by about 23% with about 60 Hz, increased perfusion, increased movement due to spinal gating reduction of nociceptor transmission, and improved action of inhibitory pain mechanisms, all enhanced with thermal factors synergistic to reducing inflammation (cold) or increasing perfusion and fascial movement (heat). The brain's pain inhibition relies on the vagus' nerve stimulation of a location called the Periaqueductal gray matter by oxytocin. Recent work has shown that vibration induces oxytocin in women, adding yet another potential mechanism. It is believed that embodiments of the present invention can modify the muscles or fascia—for example using a three-frequency motor array with selectable amplitude levels and selectable patterns (for example five amplitude levels in eight patterns), which patterns create interference and harmonic interaction. It is thus believed that vibrational energy can provide desirable results not only by interfering with the neurologic flow of pain but also by providing physical changes to muscles and fascia, which can include for example by helping to liquify hyaluronic acid such that stuck fascia can be freed to move to a more comfortable position.

It has been found that the ion channels that respond to mechanical force (e.g. Piezo1, Piezo2) are not continually activated after prolonged exposure to a constant and unchanging vibration intensity and frequency. In order to address pain, it is helpful to rapidly change how ion channels in tissues respond to vibration of different frequencies to address inflammation, decreased blood flow, fatty changes, and pain transmission—all of which require different frequencies to arrive at different depths for varied amounts of time. This can be in response to movement, tailored for different muscle densities, locations, and configurations, and can be part of a therapeutic or pain monitor.

Some cease to respond over time, and some require increasing intensity of stimulation to continue acting. Because the body habituates to single frequencies or stimuli, to optimally address multiple aspects of tissue function and repair requires continually changing (stochastic) frequencies and the biofeedback of patients able to adjust parameters to achieve increased comfort. Likewise, to address fascial plane dynamics it's particularly helpful for a large area of tissue to be stimulated simultaneously to free the entire area of fascia that has become bound up. This is analogous to trying to slide a piece of carpet that is tacked down, it's not going to slide if only different areas are free while the remainder are glued down in the remaining areas-the entire area needs to be freed up simultaneously to slide. Accordingly, embodiment of the present invention are preferably configured and sized to provide vibrational force to fascia covering an entire muscle. In one embodiment, vibration plate 20 preferably has a patient-contacting surface area of at least about 20 square inches, and more preferably at least about 24 square inches.

Embodiments of the present invention reduce chronic pelvic pain. Chronic pelvic pain is a significant contributor to depression, lack of mobility, and decreased quality of life, affecting almost 40% of adults in their lifetimes. Medications for treatment of Interstitial cystitis (“IC”), bladder pain syndrome (“BPS”) and pelvic pain may have significant side effect profiles, including nephrotoxicity, immunosuppression, and maculopathy with marginal long-term improvement of symptoms. Other options for pain control involve trigger point injection/nerve blocks as well as surgical intervention—including neuromodulation, with bladder removal for extreme cases. For patients managing their pain with opioids, fear of pain is a barrier to weaning from the medication. An effective drug-free solution for both acute and chronic pelvic pain can reduce the risks of treatment, and improve quality of life.

Heat, ice, acupressure, myofascial trigger point massage, whole body vibration, low frequency focal vibration, and high frequency vibration—with and without ice, all reduce pelvic pain. Transcutaneous electrical nerve stimulators (“TENS”) can inhibit acute pain, but only one external sacral device has been tried for pelvic pain. Recent taskforces evaluating effective chronic pain solutions support a multi-modal biopsychosocial approach; any single treatment, whether pharmacologic, physical, or psychosocial, rarely exceeds a 30% reduction in chronic pain. Increasing resources for control of pain increases self-efficacy, reduces catastrophizing, and is particularly needed when shame or privacy prohibits support groups and awareness. There are currently no multimodal devices on the market for pelvic pain. In addition, inconsistent clinical efficacy of individual alternative treatments, time, lack of reimbursement and bias often limit clinicians' recommendation of multiple non-pharmacologic pain relief methods. Embodiments of the present invention, which can optionally be used by a patient at home can provide a combination of multiple modalities of acute pain relief into a single unit, intrinsically empowering patients and reducing catastrophizing, can change the single-solution paradigm which has been insufficient to address chronic pain.

Embodiments of the present invention can be attached to a patient's pelvic area and can combine external neuromodulatory gate control pain relief with cold and vibration; mechanical and central pain relief using heat; acupressure operating using gate control; and the catastrophizing-reducing premise of combining multiple modalities in one device.

Acute pain results from fast Aδ nerves transmitting nociceptive information to the dorsal column, where the substantia gelatinosa's interneurons prioritize competing Aδ, Aβ mechanoreceptor and C-fiber slow pain transmission. The most intense sensations are passed by the interneurons to trigger T-receptors' spinothalamic transmission to the cingulo-frontal cortex. In addition to injury and external forces, cytokines and interleukins trigger Aδ pain via inflammatory pathways. Stimulation of Aβ mechanoreceptors “shut the gate” on pain transmission, an inhibitory mechanism known as “Gate Control”. Of the four principal mechanoreceptors innervated by Aβ fibers, fast adapting light touch Meissner corpuscles detect frequencies between 20 and 40 Hz, while fast reacting and long acting deep Pacinian corpuscles begin sensing vibration at 65 Hz, with maximal sensitivity at 250 Hz. Slow acting Meckel receptors sense pressure over time. Longitudinal stretching of slow-acting Aβ Ruffini bulbous corpuscles, in concert with the Ia and II afferents on the muscle spindles that share the anatomical path to the substantia gelatinosa of the dorsal horn, centrally mediate pain relief with stretching and larger amplitude vibration.

While the anatomical structures giving rise to pelvic pain are diverse, the innervation of the urinary, reproductive, and low gastrointestinal systems all include the somatic T12-S5 and visceral T10-S5 nervous system. All visceral afferents go to the dorsal root ganglia and are impacted by the large afferent posterior column modulation in the same way peripheral pain transmission is. Thus, fast Aδ nerves transmitting nociceptive information can be addressed and overridden in the substantia gelatinosa of the pelvis as with other gate control mediated pain relief.

Multiple physical methodologies leverage gate control physiology for pain relief. By electrical stimulation of one frequency (typically in the 60-120 Hz range), TENS units stimulate the lower range of Pacinian corpuscle inhibition. Direct stimulation of multiple mechanoreceptors simultaneously, as with massage, relieves pain with Aβ pain inhibition, increased blood flow to remove lactic acid from overuse or injury, and improved mobility by mechanically separating myosin and actin fibers in muscles.

Different vibratory frequencies affect pain and anabolic pathways. Compared to 15 minutes of massage, it has been found that 5 minutes of a 50 hz vibration source directly applied to muscles prior to exercise reduced delayed onset muscle soreness and LDH production, and increased range of motion at 48 and 72 hours. Focal vibration at 150 Hz improves post-operative quadriceps mass, 25-30 Hz improves circulation by decreasing arterial stiffness, and 180 Hz vasodilates at low amplitudes. 100 Hz vibration is effective for both TMJ pain and sharp injection pains.

Cold also provides peripheral gate-control relief via small, slow C-Fibers that transmit low level pain. In addition to local pain relief, like running a burn under cold water, intense cold can raise the Aδ pain threshold distant to the location. Injections, aches, and infiltration of local anesthesia and dermal fillers are relieved by applying cold. For acute injury, near freezing cold relieves pain by suppressing the local metabolic production of inflammation and concomitant tissue ischemia from hypoxia due to the increased metabolic rate. Compression ensures uniform application of cold improving efficacy; because cooling alone causes increased stiffness and decreased elasticity of muscles, cryotherapy benefits may be reduced by the mechanical side effects of cold.

The mechanisms of heat to reduce pain can include decreased spasm and improved flexibility. As a source of relaxation, heat can decrease central sensitization and anxiety, both of which contribute to pain.

Vibration activates gate control pain relief, but can also benefit pelvic pain through reducing wasted effort lost through diminished core proprioception and by improving muscle strength and size. Below a mechanical strain threshold, muscles atrophy and bone is resorbed. On both tissue and cellular levels, stressors that exceed the minimum strain threshold prompt growth. Movement can directly trigger cells to open sodium channels resulting in action potentials; integrins on cells recognize and respond to mechanical stressors at a cellular and genetic level. Vibration acts as a mechanical signal that exceeds the minimal strain level, increasing cellular anabolic activity. Walking, for example, generates vibratory waves with a frequency between 10-20 Hz. Low amplitude vibration decreases osteoclast activity, changes gene expression of growth factors, and increases growth hormone.

The increase in circulation and mechanical muscle separation with pelvic vibration can overcome the issues of spasm, and behave like heat in mitigating pain through circulatory clearing of catecholamines and speed of repair.

Research on focal vibration initially focused on morbidity: when high amplitude or duration vibration exceeds the threshold for a growth response, damage results. Low pressure 200 Hz or moderate pressure 50-150 Hz is believed to be most effective. Because proprioception impacts LBP, vibration can improve pain through multiple pathways.

Persistent pain from nociceptive triggers over time leads to hypersensitivity and reinterpretation of non-noxious signals as painful. The combination of this neuropathic and nociceptive signaling leads to long term structural changes in the thalamus and elsewhere that are a hallmark of chronic pain. Both acute and chronic pain treatments must physiologically inhibit Aδ pain centrally and reduce local inflammation; for chronic pain it is also necessary to create sensations of comfort to down-regulate central sensitization. Because increasing resources for control of pain reduces catastrophizing, using multiple non-pharmaceutical pain intervention options is a critical part of chronic pain management.

In known practice, medications are the primary or only pain control option caregivers prescribe for home use. While pain propels the opioid crisis, effective pain relief modalities are understudied or underutilized. A freezing confluent cold with a heat and vibration modality to decrease stiffness, increase comfort and increase blood flow has not previously been created nor studied. The optimal vibration frequency or combining individual frequencies with different physiologic pathways has not been studied. Whether multiple home options reduce the fear of pain, and the efficacy of external pain relievers to reduce opioid use have not been studied. A critical barrier to progress reducing pelvic pain is the lack of an effective multi-modal non-pharmaceutical consumer pain relief device.

Embodiments of the present invention can be used with a frozen clay ice pack or an electric cooler for gate-control and CPM neuromodulatory physiologic pain relief, and instant hot packs that achieve a temperature of about 110 degrees Fahrenheit, or an electric heater, to reduce muscle spasm and central sensitization.

Embodiments of the present invention can provide an alternative to risky treatments and/or opioids can be reduced or eliminated with availability of a pain relief to an apparatus according to embodiments of the present invention. This is not just for IC/BPS but other acute and chronic pain conditions. Conceptually it challenges the pharmaceutical focus of current pain strategies, and support reimbursement of multimodal neuromodulation for pain and as an important part of addressing the opioid crisis, changing practice in the field of pain relief and rehabilitation. The technical capability for multimodal neuromodulatory interventions developed can reduce suffering and disability of millions by creating an effective, drug-free pelvic pain reliever.

No external devices have been studied with opioid reduction as an outcome. Intentionally supporting the idea that one patient's chronic pain requires different treatments over time, and incorporating varied frequencies, pressures, and temperatures in one device has never been done.

Optionally, embodiments of the present invention can include a microcontroller, programmable logic controller, microprocessor, application specific integrated circuit (“ASIC”), field programmable gate array (FPGA), logic circuit, and/or a combination thereof. One or more processors and/or microcontrollers can operate via instructions of computer code and the software, if used, is preferably stored on one or more tangible non-transitive memory-storage devices.

The terms, “a”, “an”, “the”, and “said” mean “one or more” unless context explicitly dictates otherwise. Note that in the specification and claims, “about”, “approximately”, and/or “substantially” means within twenty percent (20%) of the amount, value, or condition given.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A method for providing treatment, the method comprising:
attaching a vibration plate to a patient;
activating a first vibration motor that is rigidly attached to the vibration plate such that the first vibration motor emits or otherwise imparts at least a first frequency;
activating a second vibration motor that is rigidly attached to the vibration plate such that the second vibration motor emits or otherwise imparts at least a second frequency;
creating a harmonic combination of the first frequency and the second frequency within the rigidly attached vibration plate and transferring the thusly-created harmonic combination into tissue of the patient; and
thermally heating or cooling the vibration plate with a heating and/or cooling source while the first and second vibration motors are activated.

2. The method of claim 1 further comprising activating a third vibration motor, rigidly attached to the vibration plate to emit or otherwise impart at least a third vibration frequency.

3. The method of claim 1 further comprising modulating at least one of the first vibration motor and/or the second vibration motor such that a vibration frequency created thereby is caused to modulate.

4. The method of claim 1 further comprising modulating the first vibration motor and the second vibration motor such that a vibration frequency created by the first motor and a vibration frequency created by the second motor is caused to modulate.

5. The method of claim 1 wherein a modulation pattern of the first motor is different from a modulation pattern of the second motor.

6. The method of claim 1 wherein the treatment comprises pain relief.

7. The method of claim 1 wherein the treatment comprises restoration of tissue function.

8. The method of claim 1 further comprising activating a third vibration motor rigidly attached to the vibration plate.

9. The method of claim 1 wherein thermally heating or cooling the vibration plate with a heating and/or cooling source comprises heating the vibration plate with an electric heater.

10. The method of claim 1 wherein thermally heating or cooling the vibration plate with a heating and/or cooling source comprises cooling the vibration plate with an electric cooler.

11. The method of claim 1 wherein thermally heating or cooling the vibration plate with a heating and/or cooling source comprises providing an externally heated or cooled thermal pack.

12. The method of claim 1 further comprising providing a plurality of pre-programmed, user selectable vibration settings.

13. The method of claim 1 further comprising allowing a user to manipulate an intensity level of at least one of the first or the second vibration motors.

14. The method of claim 1 further comprising shaping the vibration plate to at least substantially conform to at least a portion lower back of a person.

15. A method for improving the ability of fascia to move with respect to a muscle, the method comprising:
attaching a multi-frequency vibration apparatus to the patient such that a vibration plate thereof is disposed on an exterior of the patient nearest the fascia;
activating a plurality of motors at frequencies that cause a harmonic combination to be formed in the vibration plate.

16. The method of claim 15 wherein the method further comprises modulating a frequency of at least one of the plurality of motors.

17. The method of claim 16 further comprising modulating a frequency of the first motor and a frequency of the second motor.

18. The method of claim 15 further comprising applying heat to the vibration plate.

19. The method of claim 18 further comprising removing heat from the vibration plate to provide a cooling effect to the patient.

20. The method of claim 16 wherein attaching a multi-frequency vibration apparatus to the patient comprises attaching the multi-frequency vibration apparatus against a lower back of the patient.
